(19) United States
(12) Patent Application Publication
(10) Pub. No.: US 2003/0218150 A1
(43) Pub. Date: Nov. 27, 2003

(54) Additive compositions for cooling systems

(75) Inventors: Thomas J. Blakemore, Flossmoor, IL (US); Yu-Sen Chen, Naperville, IL (US); Heather Michalesko, Glenwood, IL (US)

Correspondence Address: STOUT, UXA, BUYAN & MULLINS LLP, 4 VENTURE, SUITE 300, IRVINE, CA, 92618, US

(73) Assignee: Dober Chemical Corporation, Midlothian, IL

(21) Appl. No.: 10/375,934

(22) Filed: Feb. 26, 2003

Related U.S. Application Data
(60) Provisional application No. 60/360,482, filed on Feb. 26, 2002.

(51) Int. Cl. C09K 5/00

(52) U.S. Cl. 252/73; 252/74; 252/75; 252/76

(57) ABSTRACT

A chemical composition and method of deployment into a coolant or coolant systems to provide at least one benefit to the system. The additive compositions includes a silicate component and a silicate stabilizer, the compositions being in the form of a solid, a non-flowable semi-solid or a flowable semi-solid which is dissolved into a coolant and enters the cooling system so as to provide at least one benefit to a coolant system when released, for example, to protect an engine. The method of deployment into the coolant and subsequently the cooling systems includes injecting or dissolving the additive into the coolant, forming the additive to the housing of the system or forming the coolant to the filter located in the housing of the cooling system.

### FIELD OF THE INVENTION

The present invention is directed to additive compositions effective to protect coolant systems, for example, engine coolant systems.

### BACKGROUND OF THE INVENTION

It has been known in the art to use Extended Life Coolant, also known as Texaco Extended Life Coolant or TELC, which includes organic acids (carboxylates) as the active ingredients in such coolant, to provide a novel approach to engine protection. TELC has been observed to provide extended service life to the engine because the acid based additives are not depleted as quickly during engine operation as are the compounds found in conventional coolants. Furthermore, the organic acid technology protects the coolant system without the use of conventional abrasive corrosion inhibitors such as silicate and phosphate. To that end, TELC reduces the cost of engine operation because it simplifies the periodic maintenance and requires less frequent coolant change relative to conventional coolants.

It has be observed that maintenance of TELC is much simpler, after 300,000 miles, 6000 hours or engine use, or 21/2 years, whichever comes first, a bottle of Texaco Extender may be added to the cooling system. It is estimated that the addition of TELC can provide an additional 300,000 miles, 6,000 hours or 21/2 years of protection to the engine. After a total of 600,000 miles or 12,000 hours, the coolant may be drained and the system flushed and refilled.

Although TELC has many advantages it has been shown, for example, that the coolant may detrimentally affect cooling systems or its components, resulting in leakage.

Accordingly, there remains a need for the development of a cooling system additive which can prevent damage to the cooling systems caused by the coolants for example those described above.

### SUMMARY OF THE INVENTION

The present invention relates to additive compositions which provide for protection of cooling systems employing certain coolants.

The chemical composition of the present invention is a coolant additive which comprises a silicate powder and a silicate stabilizer. The compositions of the present invention are useful in cooling systems, for example, engine cooling systems, which contain coolant, for example, an organic coolant. The present chemical compositions are particularly useful in coolants that include an organic acid for example, a carboxylic acid such as 2-ethylhexanoic acid, sebacic acid and the like and mixtures thereof.

The compositions of the present invention may be a solution, a flowable semi-solid, a semi-solid or a solid. In one embodiment, the compositions are in the form of a slurry which may be similar to those described in U.S. Pat. No. 5,071,580, which is incorporated herein by reference. In one embodiment, slurries have physical properties similar to the physical properties of semi-solids, for example, flowable semi-solids and in another embodiment, slurries have physical properties identical to the physical properties of semi-solids, for example, flowable semi-solids. The compositions are typically effective to provide at least one benefit to a coolant system when released into a coolant.

In one embodiment, the silicate components include one or more metal silicates, for example, active metal silicates. It is understood that the silicate components may be in any suitable form, for example, a powder form or a granular form. The metal silicates may be present in certain approximate ratios of silicon to metal. Thus, metal silicates may be considered as having one or more SiO₂ units and one or more MO units. Of course, the ratio of SiO₂ units to MO units and thus the make-up of the MO units are selected to provide a stochiometrically consistent or compatible compound. For example, MO may be Na₂O, M being Na₂; MO may be CaO, M being Ca and the like. The metals may be for example, alkali metals or alkaline earth metals and other non-transition metals including, but not limited to, sodium, potassium, calcium, magnesium or mixtures thereof. Examples of silicates that may be useful in the present invention include Ca₃SiO₅, Ca₂SiO₄, Ca₂SiO₄ and CaSiO₃, MgSiO₃, K₂SiO₃, K₂Si₂O₅, KHSi₂O₃, K₂Si₄O₉.H₂O, Na₄SiO₄, Na₂Si₂O₅, Na₂SiO₃, Na₂SiO₃.5H₂O. The silicate powder can be present in any quantity, for example, about 20% to about 60% of the composition may be silica powder. Any suitable silicate stabilizer component may be employed in the present invention, provided it functions as desired, for example, to stabilize the silicate without causing undue or significant interference or harm to the silicate component, the coolant or the coolant system.

Tn the present invention, the silicate stabilizers include organophosphorous-silicon-containing compounds and like compounds. More preferably, the silicate stabilizer component comprises one or more compounds having the formula:

(RO)₃Si(CH₂)ₙ—O—P(O)(CH₃)—OM

wherein R is a hydrogen atom or an alkyl group of about 1 to about 4 carbon atoms, M is a metal and n is an integer of about 1 to about 8. The metal may be for example, alkali and alkaline earth metals and other non-transition metals including, but not limited to, sodium, potassium, calcium or magnesium and mixtures thereof. The silicate stabilizer component may be present in any suitable, e.g., effective amount, for example, about 5% or less or about 10% to about 30% or about 40% or about 60% or about 70% or more, by weight of the present compositions.

The compositions of the present invention may have a ratio of silicate component, for example metal silicate to silicate stabilizer component in the range of about 1 to about 4 or about 1.5 to about 2.5; however, it will be understood that the invention is not limited to these ratios. Examples of ratios of silicate component to silicate stabilizer include, without limitation, about 2.07, about 2.77 or about 3.41.

The compositions may be a non-flowable semi-solid or a solid, for example, below the temperature at which the composition is flowable. The compositions of the present invention may be flowable at a temperature of about 100° F. to about 250° F. However, flowability of the compositions is not limited to any particular temperature. For example, the present compositions may be flowable at low temperatures, for example, at temperatures in a range of about 0° F. to about 100° F., for certain periods of time before becoming non-flowable. In another embodiment, the compositions become flowable at about 130° F. to about 180° F., for example, about 170° F. In one embodiment, the compositions melt and dissolve in solution at certain temperatures, for example, temperatures above which a composition is flowable. For example, one such composition may melt and dissolve in solution at a temperature between about 140° F. and about 210° F. or greater, for example, about 190° F. or greater. The compositions may dissolve in solution at lower temperatures, for example, at temperatures in a range of about 0° F. to about 140° F. The rate at which the compositions dissolve may be slower at a lower temperature.

It is also understood that the additive compositions may be formed to a certain shape. For example, the compositions may be formed to the shape of a part of a cooling system. In one embodiment, the compositions of the present invention are formed to the shape of the inside of a housing, which includes a cooling inlet and a cooling outlet. In practice the housing may also include a filter, therein. In one embodiment, the additive composition is injected into a housing, for example, a housing which includes a filter, while the additive composition is heated and in a flowable semi-solid form. In another embodiment, upon cooling, the additive composition becomes a non-flowable semi-solid or a solid, which is formed to the inside of the housing. The forming may be to any surface included inside of a housing, including, for example, the surface of a filter. In one embodiment, the compositions are initially present in the housing as a flowable semi-solid. It is understood that the additive compositions may be formed to any internal surface of a cooling system.

In another embodiment of the present invention the compositions include an organic acid and/or a derivative thereof. The organic acid may be, for example, and without limitation, sebacic acid or a derivative thereof. In another embodiment of the present invention, the compositions include about 5% to about 30% sebacic acid or a derivative thereof or mixtures thereof.

The compositions of the present invention contemplate various additive assemblies. These assemblies may include a housing which includes a coolant inlet, a coolant outlet and an additive composition of the present invention. In one embodiment, the housing includes a filter. In one embodiment, the compositions of the present invention are formed to the housing. The compositions of the present invention may also be injected into the housing, which may include a filter.

The present invention also provides methods of using additive compositions. These methods may include contacting an additive composition of the invention with a coolant and methods of producing an additive assembly such as, for example, forming an additive composition, for example, an additive composition of the present invention, to a housing which includes a coolant inlet and a coolant outlet and which may include a filter.

Any and all features described herein and combinations of such features are included within the scope of the invention provided that such features of any such combination are not mutually inconsistent.

Additional aspects and advantages of the present invention are set forth in the following description and claims, particularly when considered in conjunction with the accompanying drawings in which like parts bear like reference numerals.

### BRIEF DESCRIPTION OF THE DRAWINGS

FIG. 1 is a front elevational view of a coolant additive assembly according to a general embodiment of the present invention.

FIG. 2 is a front elevational view of a coolant filter assembly according to a general embodiment of the present invention.

FIG. 3 is a front elevational view of a coolant filter assembly according to another general embodiment of the present invention.

### DETAILED DESCRIPTION OF THE INVENTION

The present invention relates to additive compositions for use in cooling systems including circulating cooling systems and open circulating cooling systems. In one embodiment, the additive compositions are used in engine circulating cooling systems. However, it can be understood that the additive compositions of the present invention may also be used in an open circulating cooling system of cooling towers.

In one embodiment, the cooling systems of this invention employ organic coolants. The organic coolants may comprise about 20% to about 70%, for example, about 30% to about 60%, or about 50%, of an organic solvent. In one embodiment, the organic solvent may be glycol and the like, for example, an organic coolant in accordance with this invention may be composed of glycol/water, for example, the organic coolant has one part glycol and one part water.

In one embodiment, the cooling systems of the present invention employ Organic Acid Technology (OAT) coolants. Antifreezes with OAT corrosion inhibitors contain organic acid salts of mono- and dicarboxylic acids such as sebacic, octanoic acids and 2-ethylhexanoic acids and the like, and optionally, tolytriazole and the like. Such a coolant is less alkaline and protects with a pH level of only about 8.5. It is understood in the art that OAT coolants contain orange and/or red dye to distinguish them from other coolants with conventional additive packages.

In one embodiment, the additive compositions of the present invention prevent, or substantially prevent, the organic coolant from damaging the cooling systems. For example, it is known that organic coolants attack or degrade cooling system components such as components which comprise elastomers and/or silicones. Such degradation in a cooling system will lead to leaking and/or failure of the cooling system.

In a broad embodiment, the additive composition comprises a silicate stabilizer component and a silicate component. In one embodiment, the additive composition of the present invention is a flowable semi-solid. In another embodiment, the additive composition is a semisolid. A “semi-solid” is a viscous substance having certain properties of both a liquid and a solid. A semi-solid does not necessarily maintain a certain shape and may be flowable.

A composition according to the present invention comprises about 10% to about 60%, for example, about 25% to about 35%, of the silicate stabilizer component. In another embodiment, the compositions of the present invention comprise about 40% to about 60%, for example, 50%, of a silicate stabilizer. Examples of silicate stabilizers are disclosed in U.S. Pat. No. 4,370,255 issued to The Dow Corning Corp. and which is incorporated herein by reference. In one embodiment, the silicate stabilizer functions as an anti-gelling compound. Silicate stabilizers that are particularly useful in the present invention include silicon phosphonate compounds. In one embodiment, the phosphonate compound is an organophosphorus-silicon compound having the formula:

(RO)₃Si(CH₂)ₙ—O—P(O)(CH₃)—OM

wherein R is a hydrogen atom or an alkyl group of about 1 to 4 carbon atoms, M is a metal and n is an integer of about 1 to about 8. An example of a commercially available phosphonate compound is Q1-6083 which has an activity of about 42% wt/wt. Q1-6083 is produced by Dow Corning Corporation, Midland, Mich.

In one embodiment, the silicate powder is a water-soluble silicate. Water-soluble silicates include metal silicates such as sodium silicates and potassium silicates primarily because they have high water solubility, are lower in cost, and are more widely available. In one embodiment of the present invention, the metal silicates, for example, sodium silicate (SiO₂/Na₂O) or potassium silicate (SiO₂/K₂O), may have SiO₂/M₂o ratios of about 1 to about 5, for example, about 1.5 to about 4, or about 1.6 to about 3.3. It can be understood that the present invention also contemplates SiO₂/M₂O ratios below 1 and above 5.

Typically, there is an inverse relationship between the ration of SiO₂ to M₂O and solubility. For example, a higher weight ratio of SiO₂ to M₂O may result in a lower solubility. Examples of suitable water-soluble silicate powders include those available under the trade designations BRITESIL®, a C₂₄ hydrous sodium polysilicate powder with a SiO₂ to Na₂O weight ratio of 2.4, GD®, a sodium silicate powder with a SiO₂/Na₂O weight ratio of 2, and KASOLV®, a potassium silicate powder with a SiO₂/K₂O weight ratio of 2.00. Each of these silicate powders may be available from the PQ Corporation, Valley Forge, Pa. Silicate powders from the PQ Corporation may be employed in accordance with the present invention. For example, in one embodiment Sodium Silicate G having an SiO₂/Na₂O ratio of about 3.22, or Sodium Silicate GD having an SiO₂/Na₂O ratio of about 2.00, may be used. Aqueous solutions of water-soluble silicates are available under the trade designation TEX-SIL BP-42 (42% solids) from Chemical Products Corp., Cartersville, Ga.

Without wishing to limit the invention to any theory of mechanism of operation, it is believed that the higher SiO₂/Na₂O ratio in a silicate component, the lower the pH that is produced when the silicon component is added to an aqueous solution such as a coolant. Production of a lower pH may be preferred for application of a silicate component in a coolant, for example, an Organic Acid Technology coolant. Silicate powders with a higher SiO₂/Na₂O ratio may also have inferior solubility compared to those with a lower SiO₂/Na₂O ratio. It may be desirable to balance the SiO₂/Na₂O ratio to produce an optimum pH value balanced with optimum solubility.

One or more silicate components may be used in additive compositions of the present invention. The compositions may comprise about 5% or about 10% to about 60% or about 70%, for example, about 25% to about 55%, or about 30% to about 40%, of silicate component.

The ratio of silicate component to silicate stabilizer may be present in the additive composition at any ratio. In one embodiment, the silicate component/silicate stabilizer is present in the additive compositions at ratios of about 1 to about 4, or about 2.07 to about 3.41, for example, about 2.77. In one embodiment, these ratios are effective in providing for a composition in the form of a flowable semi-solid. For example, a flowable semi-solid composition may comprise a silicate component/active Q1-6083 silicate stabilizer mixture having a ratio of about 1 to about 4, for example, about 2.07 to 2.77 or about 2.77 to about 3.41. In one embodiment of the present invention, compositions comprising a silicate component/silicate stabilizer mixture with a ratio of about 2.07 have a silicate that is well stabilized under engine operating conditions, especially for applications with Organic Acid Technology coolants.

In one embodiment, compositions comprising a silicate component/silicate stabilizer mixture with a ratio of about 1.5 to about 2.5, for example, about 2.07 are particularly useful additive compositions of the present invention. For example, additive compositions comprising a silicate component/silicate stabilizer mixture with a ratio of about 2.07 may be more stable and less likely to form a precipitate than silicate component/silicate stabilizer mixtures with a ratio of about 2.77 or about 3.41.

In one embodiment, the compositions further comprise organic acid, for example, sebacic acid (C₁₀H₁₈O₄), derivatives thereof or mixtures thereof. The addition of organic acids to compositions of the present invention is effective to reduce the pH value of a composition to a desired level. Derivatives of sebacic acids include capryl alcohol (2-octanol), capryl alcohol esters (dicapryl phtharate), 1,10-decanediol, 1,10-dichlorodecane; esters of sebacic acid: di-butyl sebacate (DBS), di-capryl sebacate (DCS), di-ethyl sebacate (DES); di-methyl sebacate (DMS): di-nonyl sebacate (DNS) and di-octyl sebacate (DOS); monoesters of sebacic acid: mono-methyl sebacate; salts of sebacic acid: disodium sebacate, piperazine sebacate, methyl ricinolate, heptanoic acid, mixed fatty acids and glycerol.

In one embodiment, the composition of the present invention may include an additive component. As used herein, the term “additive component” includes materials which can be compounded or admixed with the additive compositions and which impart beneficial properties to the coolant system, for example, an aqueous coolant system. One such example of an additive component may comprise a mixture of conventional agents typically used in aqueous systems. In one embodiment, the additive component comprises (1) a buffering component to maintain a neutral or alkaline pH which may include, for example and without limitation, alkali metal salts, phosphates, for example, sodium phosphates, borates and the like; (2) a cavitation liner pitting inhibitor component, including, for example, and without limitation, alkali metal or sodium nitrites, molybdates and the like; (3) a metal corrosion and hot surface corrosion inhibitor component, which may include, for example, and without limitation, alkali metal, salts of nitrates, nitrates and silicates, carboxylic acids, azoles, phosphonic acids, phosphonate, pyrophosphate, sulfonic acids, mercaptobenzothiazoles, metal dithiophosphates and metal dithiocarbonates and the like (One particular corrosion inhibitor that has been found to be particularly useful is a phenolic anti-oxidant, 4,4′-methylenebis (2,6-di-tertbutylphenol) and is commercially available under the trademark Ethyl 702 manufactured by Ethyl Corporation); (4) a defoaming agent component including for example, silicone defoamers, alcohols such as polyethoxylated glycol, polypropoxylated glycol or acetylenic glycols and the like; (5) a hot surface deposition and scale inhibitor component including for example, phosphate esters, phosphino carboxylic acid, polyacrylates, styrene-maleic anhydride copolymers, sulfonates and the like; (6) a dispersing component, including for example, non-ionic and/or anionic surfactants such as phosphate esters, sodium alkyl sulfonates, sodium aryl sulfonates, sodium alkylaryl sulfonates, linear alkyl benzene sulfonates, alkylphenols, ethoxylated alcohols, carboxylic esters and the like; (7) an organic acid, including for example, adipic acid, sebacic acid and the like; (8) an anti-gel such as that disclosed by Feldman et al in U.S. Pat. No. 5,094,666, the disclosure of which is incorporated in by reference. Such anti-gel additive may comprise, for example, copolymers of ethylene and vinyl esters of fatty acids with a molecular weight of about 500 to about 50,000, or Tallow amine salt of phthalic anhydride, used at about 0.01% to about 0.2%, or Tallow amine salt of dithio benzoic acid, used at about 0.005% to about 0.15%, or 4-hydroxy,3,5-di-t-butyl dithiobenzoic acid, or ethylene-vinylacetate copolymers) and/or microbiocides, for example, microbiocides used in open circulating cooling water systems of cooling towers, as disclosed by Sherbondy et al. in U.S. Pat. No. 5,662,803, the disclosure of which is incorporated herein by reference.

In one embodiment, the additive component includes nitrite compounds, in such embodiment, a minimum nitrite concentration level of about 800 ppm is employed. In another embodiment, the additive component includes a mixture of nitrite compounds and molybdate compounds. In such an embodiment, the preferred minimum level of nitrite in the cooling system may be about 400 ppm one such an additive is sold by Fleetguard under the trade name DCA-2+, which includes borate, silicate, organic acids, tolytriazole, scale inhibitors, surfactants and defoamers, in addition to nitrite and molybdate.

In another embodiment, the additive component includes a mixture of nitrite, nitrate and molybdate compounds. In still another embodiment, the additive component comprises nitrite, nitrate, phosphate, silicate, borate, molybdate, tolyltriazole, organic acids, scale inhibitors, surfactants and defoamer. Such an additive is sold by Fleetguard under the trademark DCA-4+.

In one embodiment of the present invention, the composition of the present invention is fitted into a filter. In such embodiment, the composition has malleable characteristics such as that of a flowable semi-solid, so that it can be injected into a coolant filter. In one embodiment, a composition is produced as a flowable semi-solid and inserted into a filter while still warm so that upon cooling, the flowable semi-solid forms a non-flowable semi-solid or a solid.

In one embodiment of the present invention, a filter containing a composition of the present invention is installed in a new vehicle. When the engine of the vehicle is initially run, the composition, which may be in the form of a solid, a non-flowable semi-solid or a flowable semi-solid, dissolves and enters the into coolant system. For example, as soon as the engine runs, the additive composition of the present invention dissolves readily, for example, immediately, into a solution and enters into the coolant system.

Without wishing to limit the invention to any specific mode of operation, it is understood that the additive composition of the present invention can dissolve into solution upon contact with a coolant, for example, the Organic Acid Technology coolant discussed herein. In one embodiment, the additive composition is substantially or completely dissolved into solution within about 3 hours, for example, less than about 2 hours, or less than about 1 hour, from point of contact with a coolant. It is further believed that an elevated temperature, for example, a temperature of about 190° F., facilitates the process of dissolving the additive composition into solution. In the case of an elevated temperature, the additive composition may be dissolved into solution in less than about 1 hour, for example, about 1 minute to about 50 minutes or about 1 minute to about 30 minutes. In one embodiment, the additive composition dissolves into solution in less than 30 minutes for example, about 1 minute to about 15 minutes or about 1 minute to 10 minutes from point of contact with the coolant. An additive composition may also dissolve in less that about 10 minutes for example, from less than about 5 seconds to about 5 minute, for example, about 5 seconds to about 2 minutes or about 10 seconds to about 1 minute.

In one embodiment, the additive composition is made at about 170° F. At this temperature the additive composition is in the form of a flowable semi-solid which is flowable and can be easily added into a filter, for example, pumped into a filter. Upon cooling, the flowable semi-solid additive may turn into a non-flowable semi-solid or a solid material. Preferably, the additive composition is stable in the solid form, non-flowable semi-solid form, or flowable semi-solid form. The additive composition may also remain stable when the solid form, non-flowable semi-solid form or flowable semi-solid form of the additive composition is aged, for example, aged for about 1 to about 20 years, including one embodiment, where the silicate is stable in that it does not form a precipitate.

In a broad embodiment, the present invention provides for a filter comprising an additive composition of the present invention. In one embodiment, the filter includes a composition of the present invention in a flowable semi-solid form or a non-flowable semi-solid form. In accordance with the present invention a variety of filters may be employed, for example, Fleetguard XWF 2127 Filter (Fleetguard Part # 393292900) and Fleetguard XWF 2123 Filter (Fleetguard Part # 393212000) however it is understood that such examples are in no way limiting. In one example about 130 grams to about 175 grams of the additive composition is placed into a filter for later release into the cooling system.

It has been discovered that the additive compositions of the present invention have the surprising effect of reducing the detrimental effect of organic coolants on elastomers and/or silicones of cooling systems. In one embodiment, the present invention provides for a liquid media comprising a silica stabilizer and a silica powder. In one embodiment, the liquid media is a coolant, for example, an engine coolant.

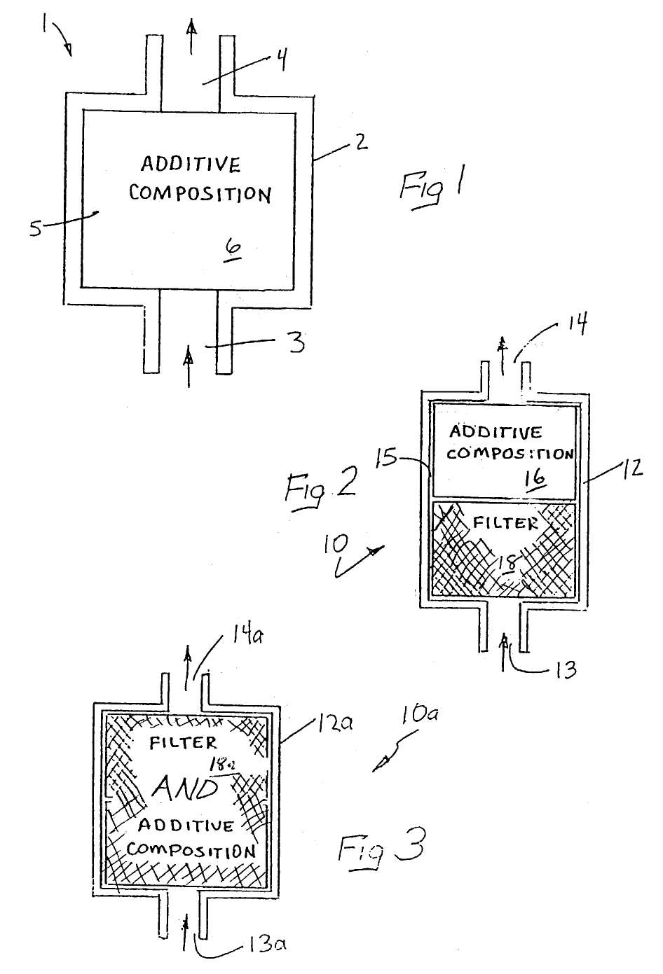

Referring to FIG. 1, an additive assembly in accordance with one embodiment of the invention is shown generally at 1. The additive assembly 1 includes a housing 2 with an inlet port 3, an outlet port 4, and a chamber 5 including coolant additive composition 6 contained therein. The additive assembly 1 is adapted to be placed at a suitable location along a coolant line, for example, in a cooling system of an internal combustion engine. Coolant flowing in the coolant line (not shown) will enter the assembly inlet port 3, flow into the chamber 5 and contact the coolant additive composition 6. The coolant additive composition 6, as described elsewhere herein, may be formed to the inside of the chamber by, for example, injecting or spraying the additive into or onto the inside of the chamber while heated and in a flowable, semi-solid form. After cooling, the composition becomes a non-flowable semi-solid or a solid. Coolant having a portion of the additive composition 6 dissolved therein then passes from the chamber 5 through the outlet port 4.

Referring now to FIG. 2, another coolant additive assembly in accordance with the present invention is shown generally at 10. The additive assembly 10 includes the basic components of construction that are typical of a conventional coolant filter. In the shown embodiment 10, a housing 12 is provided which includes inlet port 3, outlet port 4, and chamber 15. As shown, the housing 12 is adapted to contain both the coolant additive composition 16 and a filter element 18 in chamber 15. The additive composition may be applied to the inside of the housing and/or to the filter while heated and in a flowable, semi-solid form. After cooling, the composition becomes a non-flowable semi-solid or a solid.

The inlet port 13 receives coolant into the housing 12. The filter component 18 disposed within the housing 12 filters the coolant. During filtering, the coolant comes into contact with the additive composition 16. The additive composition 16, is released into the filtered coolant. The filtered coolant containing additives exits the housing 12 through the outlet port 4 and travels to downstream components of the coolant system.

FIG. 3 illustrates another embodiment of the invention, coolant additive assembly 10a. The additive composition may be applied to the to the filter while heated and in a flowable, semi-solid form. For example, the additive composition may be injected into and/or onto the filter. After cooling, the composition becomes a non-flowable semi-solid or a solid. In assembly 10a, coolant in a coolant line enters housing 12a through inlet port 3a and contacts the additive composition 16a before being filtered through filter element 18a. Filtered coolant containing the additives then exits the filter assembly via the outlet port 14a.

The coolant additive compositions may be applied to, for example, formed to, e.g., coated onto the inside of the additive assembly by, for example, injecting or spraying the additive into or onto the inside of the chamber which may contain a filter, while in a suitable form, for example, a flowable semi-solid form. In one embodiment, the composition is coated on the additive assembly, for example, coated on the chamber. In another embodiment, the composition is coated on the filter. In another embodiment, the composition is coated on the additive assembly, for example, coated on the chamber, and coated on the filter. The additive composition may be at any suitable temperature when applied, for example, a temperature at which the additive composition is in a flowable, semi-solid form.

The following non-limiting examples illustrate certain aspects of the present invention.

### EXAMPLE 1

### Method of Making the Composition

A composition comprising, by weight, about 17.55% de-ionized water, about 35.76% Q1-6083, which is a silicate stabilizer, and about 46.69% GD sodium silicate, which is a silicate powder, may be produced by the following method:

Add water to a stainless steel tank or container. Add Q1-6083 to the container and mix gently with a Greerco mixer (Greerco Corp., Hudson, N.H.) for about 3 to about 7 minutes. Subsequently, gradually add the GD-sodium silicate powder. The mixing will generate heat and raise the temperature of the mixture. Once all the silicate powder is added, mix for an additional 25 to 35 minutes, or until the temperature of the mixture reaches about 170° F. to about 180° F., giving a homogenous creamy and flowable semi-solid.

In cases where foaming occurs, a defoamer, such as, pluronic LH 61, BASF, agent may be added, for example, 10 grams for each 1000 grams of the composition.

### EXAMPLE 1B

### Method of Making the Composition

A composition comprising, by weight, about 10.06% de-ionized water, about 50.18% Q1-6083, which is a silicate stabilizer that is about 42% active; and about 39.76% GD sodium silicate, which is a silicate powder, may be produced by the following method:

Add water to a stainless steel tank or container. Add Q1-6083 to the container and mix gently with a Greerco mixer (Greerco Corp., Hudson, N.H.) for about 3 to about 7 minutes. Subsequently, gradually add the GD-sodium silicate powder. The mixing will generate heat and raise the temperature of the mixture. Once all the silicate powder has been added, mix for an additional 25 to about 35 minutes, or until the temperature of the mixture reaches about 170° F. to about 180° F. creating a homogenous creamy and flowable semi-solid.

In cases where foaming occurs, a defoamer, for example, pluronic LH 61, BASF, agent may be added, for example, 10 grams for each 1000 grams of the composition.

The composition is in the form of a flowable semi-solid, 145 grams of this flowable semi-solid can then be placed into a filter for use in a coolant system, for example, a 13 gallon coolant system, more particularly, a 13 gallon engine coolant system.

### EXAMPLE 1C

### Method of Making the Composition

A composition comprising, by weight, about 13.96% de-ionized water; about 41.74% Q1-6083, which is a silicate stabilizer; for example, about 42% active; and about 44.30% GD sodium silicate, a silicate powder, may be produced by the following method:

Add water to a stainless steel tank or container. Add Q1-6083 to the container and mix gently with a Greerco mixer (Greerco Corp., Hudson, N.H.) for about 3 to about 7 minutes. Subsequently, gradually add the GD-sodium silicate powder. The mixing will generate heat and raise the temperature of the mixture. Once all the silicate powder is added, mix for an additional 25 to about 35 minutes, or until the temperature of the mixture reaches about 170° F. to about 180° F., creating a homogenous creamy and flowable semi-solid.

In cases where foaming occurs, a defoamer, for example, pluronic LH 61, BASF, agent may be added, for example, 10 grams for each 1000 grams of the composition.

### EXAMPLE 2

### Method of Making the Composition

A composition comprising, by weight, about 22.03% de-ionized water; about 26.94% Q1-6083, which is a silicate stabilizer; about 35.17% GD sodium silicate, which is a silicate powder; and about 15.87% of sebacic acid may be produced by the following method:

Add water to a stainless steel tank or container. Add Q1-6083 to the container and mix gently with a Greerco mixer (Greerco Corp., Hudson, N.H.) for about 3 to about 7 minutes. Subsequently, gradually add the GD-sodium silicate powder. The mixing will generate heat and raise the temperature of the mixture. Once all the silicate powder is added, mix for an additional 25 to about 35 minutes. Then, gradually add sebacic acid. After all the sebacic acid is added, mix for an additional 20 minutes, or until the temperature of the mixture reaches about 170° F. to about 180° F., producing a homogenous creamy and flowable semi-solid.

In cases where foaming occurs, a defoamer, for example, pluronic LH 61, BASF, agent may be added, for example, 10 grams for each 1000 grams of the composition.

### EXAMPLE 2B

### Method of Making the Composition

A composition comprising, by weight, about 22.02% de-ionized water; about 26.94% Q1-6083, which is a silicate stabilizer; about 35.17% GD sodium silicate, which is a silicate powder and about 15.87% of sebacic acid may be produced by the following method:

Add water to a stainless steel tank or container. Add Q1-6083 to the container and mix gently with a Greerco mixer (Greerco Corp., Hudson, N.H.) for about 3 to about 7 minutes. Subsequently, gradually add the GD-sodium silicate powder. The mixing will generate heat and raise the temperature of the mixture. Once all the silicate powder is added, mix for an additional 25 to about 35 minutes. Then, gradually add sebacic acid. After all the sebacic acid is added, mix for an additional 20 minutes, or until the temperature of the mixture reaches about 170° F. to about 180° F., producing a homogenous creamy and flowable semi-solid.

In cases where foaming occurs, a defoamer, for example, pluronic LH 61, BASF, agent may be added, for example, 10 grams for each 1000 grams of the composition.

The composition is in the form of a flowable semi-solid, 165 grams of which can be placed into one filter (for 13 gallons coolant systems) for use in a coolant system, for example, engine coolant system.

### EXAMPLE 3

### Method of Protecting Cooling Systems

Add about 2.947 grams of a composition made by the process of Example 1B to about 1 liter of coolant. The composition may deliver about 1,000 mg Na₂SiO₃ to about 1 liter of coolant.

In one embodiment the composition is a non-flowable semi-solid situated in a filter. When the engine is turned on, the semi-solid melts into solution and dissolves into the coolant thereby entering the cooling system.

### EXAMPLE 4

### Method of Protecting Cooling Systems

Add about 3.353 grams of a composition made by the process of Example 2B to about 1 liter of coolant. The composition may deliver about 1,000 mg Na₂SiO₃ to about 1 liter of coolant.

In one embodiment the composition is a non-flowable semi-solid situated in a filter. When the engine is turned on, the semi-solid melts into solution and dissolves into the coolant thereby entering the cooling system.

### EXAMPLE 5

### Na₂SiO₃/Active Q1-6083 Ratio=3.41 Experiment Done with Additive Present in a Coolant Filter

| | | | | % of | |
|---|---|---|---|---|---|
| | | | | Theoretical | |
| | | Total | | Silicon | |
| Sample | Hour | Silicon | PH | Present | Comments |
| 1 | 1 | 865 | 9.85 | 72 | overflowed 1,600 ml |
| 2 | 2 | 797 | 9.7 | 66 | |
| 3 | 3 | 802 | 9.93 | 67 | |
| 4 | 5 | 831 | 10.03 | 69 | Let cool. Pour back in |
| | | | | | all overflowed. |
| 5 | 24 | 669 | 9.85 | 56 | Flow rate turned 0.0. |
| | | | | | Needed to turn speed |
| | | | | | from 7 to 9 to have |
| | | | | | flow rate of 0.5 |
| | | | | | gal/min flow rate |
| | | | | | dropped to 0.0 again. |
| | | | | | Unable to get any flow |
| | | | | | even at speed 10. |
| | | | | | However, the filter |
| | | | | | was very hot, |
| | | | | | indicating the |
| | | | | | solution is still |
| | | | | | passing through the |
| | | | | | system; the filter |
| | | | | | maybe only partially |
| | | | | | plugged. |
| 6 | 30 | 550 | 9.83 | 46 | Could not get any flow |
| | | | | | rate reading on meter. |
| | | | | | But filter is still |
| | | | | | very hot (i.e. solution |
| | | | | | still apparently |
| | | | | | passing through). |
| 7 | 76 | 430 | 9.5 | 36 | No flow rate. Filter is |
| | | | | | cold (i.e. the filter |
| | | | | | is totally plugged.) |
| 8 | 96 | 452 | 9.65 | 38 | |
| 9 | 120 | 439 | 9.67 | 36 | |
| 10 | 172 | 415 | 9.55 | 34 | No flow through filter. |
| 11 | 194 | 405 | 9.62 | 34 | No flow through filter. |

This experiment demonstrates the stability of additive composition. in Texaco Caterpillar EC-1 Extended Life Coolant (about 3 to about 4% 2-ethylhexanoic acid, about 0.5% sebacic acid, about 0.5% tolyltriazole, about 1% to about 2% hydroxide solution and about 93% to about 95% ethylene glycol) mixed with deionized water at a ratio of 1/1 under conditions simulating the temperature and pressure found in an engine cooling system.

Silicon levels in the coolant were measured at each time point to determine total silica additive present in the coolant. A total of 40.9 grams of additive composition was added to the test system. The additive composition had an Na₂SiO₃/Q1-6083 ratio of 3.41 and was initially present at a concentration of 1,205 mg/L in the test system.

The data shows that the 3.41 ratio additive composition is stable for at least 4 hours. That is, the total silicon remained constant until the 24 hour time point, at which time the silicon level begins to drop. During the first 5 hours of the experiment the flow rate was approximately 1.3 gal/min−1.5 gal/min. The coolant filter begins to become plugged at the 24 hour time point likely indicating that the SiO₃ is beginning to precipitate from solution.

### EXAMPLE 6

### Na₂SiO_{3/}Active Q1-6083 Ratio=3.41 Experiments Done in a Flask

1. Experiment Performed in 4 L H₂O

| | | Total | % of Theoretical |
|---|---|---|---|
| Sample | Hours | Silicon | Silicon Present |
| 1 | 0 | 1111 | 86 |
| 2 | 48 | 1060 | 82 |
| 3 | 72 | 1043 | 81 |
| 4 | 144 | 1039 | 80 |
| 5 | 216 | 1050 | 81 |
| 6 | 240 | 1054 | 81 |

2. Experiment Performed in 4 L of H₂O with Phosphate Buffer, pH 8.88

| | | Total | % of Theoretical |
|---|---|---|---|
| Sample | Hours | Silicon | Silicon Present |
| 1 | 0 | 996 | 83 |
| 2 | 48 | 985 | 82 |
| 3 | 72 | 991 | 82 |
| 4 | 144 | 955 | 79 |
| 5 | 216 | 998 | 83 |
| 6 | 240 | 976 | 81 |

3. Experiment Performed in 2 L of Texaco CAT (Caterpillar Long Last) Coolant

| | | Total | % of Theoretical |
|---|---|---|---|
| Sample | Hours | Silicon | Silicon Present |
| 1 | 0 | 934 | 83 |
| 2 | 48 | 668 | 60 |
| 3 | 72 | 541 | 48 |
| 4 | 144 | 524 | 47 |
| 5 | 216 | 495 | 44 |
| 6 | 240 | 467 | 42 |

These experiments demonstrate the stability of additive composition in 1) water; 2) water with K₂HPO₄ buffer, pH 8.88 at a concentration of 3 grams per liter and 3) Texaco Caterpillar EC-1 Extended Life Coolant (about 3 to about 4% 2-ethylhexanoic acid, about 0.5% sebacic acid, about 0.5% tolyltriazole, about 1% to about 2% hydroxide solution and about 93% to about 95% ethylene glycol) mixed with deionized water at a ratio of 1/1, in open flasks at a temperature of about 190° F. 8.8 grams, 8.2 grams and 3.8 grams of additive composition produced as described in example 1 was added to the test systems 1, 2 and 3 respectively. The additive compositions each had a sodium silicate/silicate stabilizer (Na₂SiO₃/Q1-6083) ratio of 3.41.

The silicon level in the coolant was measured at each time point. The data shows that the 3.41 ratio additive composition is stable for at least 240 hours in test solutions 1 and 2 and that the total silicon level begins to drop at the first time point (48 hours) indicating a reduction in additive stability.

### EXAMPLE 7

### Na₂SiO₃/Active Q1-6083 Ratio=2.77 Experiment Done with Additive Present in a Coolant Filter

| | | | | | % of | |
|---|---|---|---|---|---|---|
| | | | Flow | | Theoretical | |
| | | | Rate | Total | Silicon | |
| Sample | Hours | pH | gal/min | Silicon | Present | % |
| 1 | 2 | 9.68 | 1.3 | 851 | 66 | 78 |
| 2 | 5 | 9.67 | 1.3 | 819 | 63 | 75 |
| 3 | 24 | 9.64 | 1.3 | 836 | 65 | 76 |
| 4 | 72 | 9.67 | 1.3 | 810 | 63 | 74 |
| 5 | 96 | 10.0 | 1.2 | 756 | 58 | 69 |
| 6 | 120 | 9.8 | 1.0 | 728 | 56 | 67 |
| 7 | 144 | 9.96 | 0 | 563 | 43 | 51 |
| 8 | 168 | 9.83 | 0 | 553 | 43 | 51 |

This experiment demonstrates the stability of additive composition in Texaco Caterpillar EC-1 Extended Life Coolant (about 3 to about 4% 2-ethylhexanoic acid, about 0.5% sebacic acid, about 0.5% tolyltriazole, about 1% to about 2% hydroxide solution and about 93% to about 95% ethylene glycol) mixed with deionized water at a ratio of 1/1 under conditions simulating the temperature and pressure found in an engine cooling system.

In a 19 L volume, 42.8 grams of additive composition was added to the test system as described hereabove in Example 1C. The additive composition had an Na₂SiO₃/Q1-6083 ratio of 2.77. The silicon level in the coolant was measured at each time point to determine total silica additive present.

The data shows that the additive composition remains stable up to 120 hours (5 days). That is, the total silicon level remains fairly constant until the 120 hour time point at which time the total silicon level begins to drop significantly and the flow rate begins to slow significantly indicating that the additive is precipitating from solution.

### EXAMPLE 8

### Na₂SiO₃/Active Q1-6083 Ratio=2.77 Experiment Done in a Flask

| | | Total | % of Theoretical | |
|---|---|---|---|---|
| Sample | Hours | Silicon | Silicon Present | % |
| 1 | 0 | 997 | 82 | 98 |
| 2 | 24 | 1019 | 84 | 100 |
| 3 | 48 | 992 | 82 | 97 |
| 4 | 74 | 997 | 82 | 98 |
| 5 | 120 | 864 | 71 | 85 |
| 6 | 144 | 778 | 64 | 76 |
| 7 | 168 | 700 | 58 | 69 |

This experiment demonstrates the stability of additive composition in Texaco Caterpillar EC-1 Extended Life Coolant (about 3 to about 4% 2-ethylhexanoic acid, about 0.5% sebacic acid, about 0.5% tolyltriazole, about 1% to about 2% hydroxide solution and about 93% to about 95% ethylene glycol) mixed with deionized water at a ratio of 1/1 in an open flask at a temperature of about 190° F.

The additive composition had a Na₂SiO₃/Q1-6083 ratio of 2.77 wherein 2.1 grams of additive composition per liter of coolant and water was produced as described hereabove in Example 1C. The silicon level in the coolant was measured at each time point to determine total silica additive present.

The data shows that the additive composition remains stable up to 120 hours (5 days). That is, the total silicon level remains fairly constant until about the 120 hour time point at which time the silicon level begins to drop significantly.

### EXAMPLE 9

### Na₂SiO₃/Active Q1-6083 Ratio=2.07 Experiments Done with Additive Present in a Coolant Filter

Experiment 1

| | | | | | | % of |
|---|---|---|---|---|---|---|
| | | Flow | | | | Theoretical |
| | | rate | | | Total | Silicon |
| Sample | Hours | gal/min | Temp. | PH | Silicon | Present |
| 1 | 2 | 1.3 | 183-193° F. | 9.11 | 807 | 62 |
| 2 | overflowed 1,720 mL | | | 9.8 | 874 | 68 |
| 3 | 4 | 1.3 | 183-193° F. | 9.2 | 800 | 62 |
| 4 | 6 | 1.3 | 183-193° F. | 9.5 | 791 | 61 |
| 5 | 26 | 1.3 | 182-192° F. | 9.05 | 760 | 59 |
| 6 | 71 | 1.3 | 183-193° F. | 9.48 | 724 | 56 |
| 7 | 120 | 1.3 | 183-193° F. | 9.65 | 697 | 54 |
| 8 | 144 | 1.3 | 182-191° F. | 9.64 | 697 | 54 |
| 9 | 168 | 1.3 | 183-192° F. | 9.6 | 705 | 54 |

Experiment 2

| | | | | | | % of |
|---|---|---|---|---|---|---|
| | | | Flow | | | Theoretical |
| | | | Rate | | Total | Silicon |
| Sample | Hours | pH | gal/min | Temp. | Silicon | Present |
| 1 | 3 | 10.04 | 1.4 | 179-187° F. | 1022 | 68 |
| 2 | 5 | 10.01 | 1.3 | 178-188° F. | 1010 | 67 |
| 3 | 24 | 9.82 | 1.4 | 181-189° F. | 934 | 62 |
| 4 | 55 | 10.06 | 1.4 | 181-189° F. | 901 | 60 |
| 5 | 72 | 9.9 | 1.4 | 181-189° F. | 893 | 60 |
| 6 | 96 | 9.86 | 1.3 | 182-190° F. | 873 | 58 |
| 7 | 147 | 9.86 | 1.4 | 182-190° F. | 868 | 58 |
| 8 | 170 | 9.85 | 1.3 | 182-190° F. | 863 | 58 |

These two experiments demonstrate the stability of additive composition in Texaco Caterpillar EC-1 Extended Life Coolant (about 3 to about 4% 2-ethylhexanoic acid, about 0.5% sebacic acid, about 0.5% tolyltriazole, about 1% to about 2% hydroxide solution and about 93% to about 95% ethylene glycol) mixed with deionized water at a ratio of 1/1 under conditions simulating the temperature and pressure found in an engine cooling system.

Each additive composition in the above experiments had a Na₂SiO₃/Q1-6083 ratio of 2.07 and was produced as described in Example 1B. In Experiment 1, 50.5 gram of additive composition was used in 19.5 L of solution. In Experiment 2, 57.1 grams of additive composition was used in 19.0 L of solution. The data in each experiment showed that an additive composition with a sodium silicate/silicate stabilizer (Na₂SiO₃/Q1-6083) ratio of 2.07 was very stable for the entire run of each experiment.

Both of these experiments indicate there was only a small, gradual loss of silicate throughout the experiment. No reduction in flow rate due to filter plugging was observed indicating that there was no significant silicate precipitation.

### EXAMPLE 10

### Na₂SiO₃/Active Q1-6083 Ratio =2.07 Experiments Done in a Flask

| | | Total | % of Theoretical |
|---|---|---|---|
| Sample | Hours | Silicon | Silicon Present |
| 1 | 0 | 1068 | 76 |
| 2 | 72 | 1118 | 80 |
| 3 | 96 | 1112 | 79 |
| 4 | 144 | 1140 | 81 |
| 5 | 172 | 1140 | 81 |
| 6 | 216 | 1097 | 78 |

This experiment demonstrates the stability of additive composition in Texaco Caterpillar EC-1 Extended Life Coolant (about 3 to about 4% 2-ethylhexanoic acid, about 0.5% sebacic acid, about 0.5% tolyltriazole, about 1% to about 2% hydroxide solution and about 93% to about 95% ethylene glycol) mixed with deionized water at a ratio of 1/1 in an open flask at a temperature of about 190° F.

Total silicon in the coolant was measured at each time point to determine total silica additive present. 2.7 grams of additive composition per liter of coolant and water was used for the experiment. The Additive composition was prepared as described hereabove in Example 1B.

The additive composition in the above experiment had a Na₂SiO₃/Q1-6083 ratio of 2.07. The data in the experiment showed that an additive composition with a Na₂SiO₃/Q1-6083 ratio of 2.07 was very stable for the entire run of each experiment with only a small, gradual loss of silicate throughout the experiment.

While this invention has been described with respect to various specific examples and embodiments, it is to be understood that the invention is not limited thereto and that it can be variously practiced within the scope of the following claims.

What is claimed is:

1. A composition comprising a silicate component and a silicate stabilizer component, the composition being in the form of a semi-solid, wherein the composition is effective to provide at least one benefit to a coolant system when released into a coolant present in the coolant system.

2. The composition of claim 1 wherein the silicate component comprises at least one metal silicate.

3. The composition of claim 1 wherein the silicate component comprises a material having a formula as follows:
SiO₂MO
wherein M is a metal.

4. The composition of claim 3 wherein the ratio of SiO₂ to MO is in a range of about 1 to about 5

5. The composition of claim 1 wherein the silicate stabilizer component comprises at least one organophosphorous-silicon containing compound.

6. The composition of claim 1 wherein the silicate stabilizer component comprises at least one compound having the formula:
(RO)₃Si(CH₂)ₙ—O—P(O)(CH₃)—OM
wherein R is a hydrogen atom or an alkyl group of about 1 to about 4 carbon atoms, M is a metal and n is an integer of about 1 to about 8.

7. The composition of claim 1 wherein the ratio of silicate component to silicate stabilizer component is in a range of about 1.5 to about 2.5.

8. The composition of claim 1 wherein the ratio of silicate component to silicate stabilizer component is about 2.07.

9. The composition of claim 1 wherein the semi-solid form is flowable.

10. The composition of claim 1 wherein the composition is flowable at a temperature of about 170 degrees F. or greater.

11. The composition of claim 1 further comprising at least one of an organic acid or a derivative of an organic acid.

12. The composition of claim 1 wherein the coolant comprises an organic acid.

13. The composition of claim 1 wherein the coolant system is an engine cooling system.

14. An additive assembly comprising:
a housing including a coolant inlet and a coolant outlet; and
an additive composition comprising a silicate component and a silicate stabilizer component, the composition being a solid or a semi-solid and being located in the housing wherein the composition is effective to provide at least one benefit to a coolant system when released into a coolant present in the coolant system.

15. The additive assembly of claim 14 wherein the additive composition is initially located in the housing as a flowable semi-solid.

16. The additive assembly of claim 14 the additive composition is injected into the housing.

17. The additive assembly of claim 14 further comprising a filter located in the housing.

18. The additive assembly of claim 17 wherein the filter has a surface; and
the additive composition is formed to the surface of the filter.

19. The additive assembly of claim 14 wherein the silicate component comprises a material having a formula as follows:
SiO₂MO
wherein M is a metal.

20. The composition of claim 18 wherein the ratio of SiO₂ to MO is in a range of about 1 to about 5

21. The additive assembly of claim 14 wherein the silicate stabilizer component comprises at least one organophosphorous-silicon containing compound

22. The additive assembly of claim 14 wherein the silicate stabilizer component comprises at least one compound having the formula:
(RO)₃Si(CH₂)ₙ—O—P(O)(CH₃)—OM
wherein R is a hydrogen atom or an alkyl group of about 1 to about 4 carbon atoms, M is a metal and n is an integer of about 1 to about 8.

23. The additive assembly of claim 14 wherein the ratio of silicate component to silicate stabilizer component is in the range of about 1 to about 4.

24. A method of producing an additive assembly comprising:
providing an additive composition comprising a silicate component and a silicate stabilizer component in a housing including a coolant inlet and a coolant outlet, wherein the additive composition is a semisolid or a solid.

25. The method of claim 24 wherein the additive composition is initially present in the housing as a flowable semi-solid.

26. The method of claim 24 wherein the additive composition is present in the housing as a non-flowable semi-solid or a solid.

27. The method of claim 24 wherein the providing step includes injecting the additive composition into the housing.

28. The method of claim 24 further comprising a filter located inside the housing.

29. The method of claim 24 wherein the silicate component comprises a material having a formula as follows:
SiO₂MO
wherein M is a metal.

30. The composition of claim 29 wherein the ratio of SiO₂ to MO is in a range of about 1 to about 5

31. The method of claim 24 wherein the silicate stabilizer component comprises at least one organophosphorous-silicon containing compound.

32. The method of claim 24 wherein the silicate stabilizer component comprises at least one compound having the formula:
(RO)₃Si(CH₂)ₙ—O—P(O)(CH₃)—OM
wherein R is a hydrogen atom or an alkyl group of about 1 to about 4 carbon atoms, M is a metal and n is an integer of about 1 to about 4.

33. The method of claim 24 wherein the ratio of silicate component to silicate stabilizer component is in the range of about 1 to about 4.

34. The method of claim 24 wherein the additive composition is flowable at a temperature of about 170 degrees F. or greater.

35. A method of producing an additive assembly comprising:
providing an additive composition comprising a silicate component and a silicate stabilizer component in a filter located in a housing including a coolant inlet and a coolant outlet, wherein the additive composition is a semisolid or a solid.
